(19) United States
(12) Patent Application Publication
(10) Pub. No.: US 2017/0128158 A1
(43) Pub. Date: May 11, 2017

(54) DENTAL MATERIAL HEATING INFUSER FOR HEATING DENTAL MATERIAL BY PELTIER ELEMENT

(71) Applicant: DXM CO., LTD, Goyang-si, Gyeonggi-do (KR)

(72) Inventors: Du Rok JUNG, Goyang-si, Gyeonggi-do (KR); Kyoung Soo SHIN, Goyang-si, Gyeonggi-do (KR)

(73) Assignee: DXM CO., LTD, Goyang-si, Gyeonggi-do (KR)

(21) Appl. No.: 15/321,782

(22) PCT Filed: Nov. 12, 2015
(86) PCT No.: PCT/KR2015/012189

§ 371 Date: Dec. 23, 2016

(30) Foreign Application Priority Data
Nov. 12, 2014 (KR) 10-2014-0157130
Nov. 12, 2014 (KR) 10-2014-0157279

(51) Int. Cl. A61C 5/55; A61C 5/62

(52) U.S. Cl. CPC A61C 5/55; A61C 5/62

(57) ABSTRACT

Disclosed is a dental material heating infuser including a housing having an open front end, a cartridge detachably coupled to the open front end of the housing and configured to accommodate a dental material therein, a needle member for outwardly discharging the dental material being coupled to the cartridge, a protective casing coupled to the front end of the housing so as to surround an exterior of the cartridge, a heating unit provided between the protective casing and the cartridge for heating the cartridge, and a cartridge drive unit for applying pressure to a rear end portion of the cartridge so that the dental material is discharged outward through the needle member. The heating unit includes a heating pipe, into which the cartridge is inserted, and a Peltier element disposed on an outer circumferential surface of the heating pipe for supplying heat to the heating pipe by Peltier effect.

### BACKGROUND OF THE INVENTION

Field of the Invention

The present invention relates to a dental material heating infuser, and more particularly, to a dental material heating infuser of which a structure is improved so as to heat a dental material using the Peltier effect.

Description of the Related Art

In a dental clinic, for the treatment of a decayed tooth, the decayed portion of a tooth is removed using a drill. When a dental pulp is damaged, the damaged or contaminated dental pulp is removed, and thereafter a root canal to be treated is filled with a dental material (e.g. cement or sealer for root canal charging) so as to enable prosthetic treatment in a sealed state.

In the case of charging the root canal, a gutta-percha cone is used as a temporary filler that assists the dental material in penetrating the root canal so as to completely close the root canal. As a charger for causing the gutta-percha cone to come into close contact with the canal wall, a dental charger (e.g. an obturator), disclosed in Korean Utility Model Laid-open Publication No. 2008-0003483 and Korean Patent Laid-open Publication No. 2008-0080470, is used.

In the disclosed conventional dental charger, a hot wire heater is used to heat a solid-state filler in order to supply the filler in a liquid state when supplying a dental material to a tooth using a needle. That is, the hot wire heater is wound around the exterior of a cartridge and heats the filler in the cartridge by heating the cartridge.

However, the conventional dental charger has a disadvantage of relatively low thermal efficiency because a large portion of the heat generated from the hot wire heater dissipates outward. In addition, because the hot wire heater heats not only the cartridge, but also an outer casing, located outside the cartridge, a patient may get burned when the mouth and lips of the patient come into contact with the dental charger.

### SUMMARY OF THE INVENTION

Therefore, the present invention has been made in view of the above problems, and it is an object of the present invention to provide a dental material heating infuser, which may ensure the safe treatment of a patient by heating only a cartridge in which a dental material is accommodated.

The above object and various advantages of the present invention will be more apparent from exemplary embodiments of the present invention by those who skilled in the art.

In accordance with one aspect of the present invention, the above and other objects can be accomplished by the provision of a dental material heating infuser including a housing having an open front end, a cartridge detachably coupled to the open front end of the housing and configured to accommodate a dental material therein, a needle member for outwardly discharging the dental material being coupled to the cartridge, a protective casing coupled to the front end of the housing so as to surround an exterior of the cartridge, a heating unit provided between the protective casing and the cartridge for heating the cartridge, and a cartridge drive unit for applying pressure to a rear end portion of the cartridge so that the dental material is discharged outward through the needle member, wherein the heating unit includes a heating pipe, into which the cartridge is inserted, and a Peltier element disposed on an outer circumferential surface of the heating pipe for supplying heat to the heating pipe by Peltier effect.

The heating pipe may be provided with a connection rib, which extends from the outer circumferential surface of the heating pipe to the Peltier element, the connection rib having a horizontal coupling area with respect to the Peltier element so as to come into surface contact with the Peltier element.

The protective casing may include a radiative casing disposed so as to come into contact with the Peltier element and formed of a metal material for outwardly discharging the heat supplied from the Peltier element, and an outer casing configured to cover an exterior of the radiative casing in order to prevent the radiative casing from coming into contact with a mouth and lips of a patient.

The Peltier element may be provided in a plural number, and the heating pipe may take the form of a polygon, of which the number of sides corresponds to the number of Peltier elements.

The housing may include an upper housing for accommodating the heating unit and the cartridge drive unit therein, and a handle housing extending downward from a rear end of the upper housing so as to be gripped by a user, and the upper housing and the handle housing may be coupled to each other to form a gun shape.

The housing may take the form of a pen for accommodating the heating unit and the cartridge therein, the protective casing being coupled to the front end of the pen-shaped housing.

In accordance with another aspect of the present invention, the above and other objects can be accomplished by the provision of a dental material heating infuser including a charger main body having a handle housing for accommodating a battery therein and an upper housing provided at an upper side of the handle housing, a chamber member coupled inside the upper housing and having a dental material insertion hole, through which a solid-state dental material from an outside is inserted into the chamber member, for accommodating the solid-state dental material therein, a needle member coupled to a front end of the upper housing for discharging a liquid-state dental material to a dental area to be treated, a heating unit for heating the solid-state dental material supplied from the chamber member so as to obtain the liquid-state dental material, a rotator coupled to a rear end of the heating unit for providing drive power required to rotate the heating unit, a piston unit movably provided inside the upper housing for pressing the solid-state dental material inside the chamber member to the heating unit, an operating unit for driving the piston unit so that the dental material is supplied to the heating unit, and a protective casing coupled to the front end of the upper housing for protecting the heating unit from an outside, wherein the heating unit includes a heating pipe connected at a rear end thereof to the chamber member and connected at a front end thereof to the needle member so that the dental material is introduced from the chamber member into the heating pipe, and a Peltier element disposed on an outer circumferential surface of the heating pipe for supplying heat to the heating pipe and cooling the protective casing by Peltier effect.

The heating pipe may have a circular cross-sectional shape, and the heating pipe may be provided on an area of the outer circumferential surface thereof with an element coupling plate, which has a flat shape and is disposed so as to come into contact with the Peltier element.

The protective casing may include a radiative casing disposed so as to come into contact with the Peltier element and formed of a metal material for outwardly discharging the heat supplied from the Peltier element, and an outer casing configured to cover an exterior of the radiative casing in order to prevent the radiative casing from coming into contact with a mouth and lips of a patient.

The Peltier element may be provided in a plural number, and the heating pipe may be provided with an element coupling plate, which is coupled to form a polygon, of which the number of sides corresponds to the number of Peltier elements.

The dental material heating infuser may further include a temperature sensor for sensing a temperature of the Peltier element, and a power board unit for supplying power to the temperature sensor and the Peltier element, wherein the power board unit may include a power board coupled between the chamber member and the rotator, and a first ring electrode and a second ring electrode concentrically recessed to a constant depth in a flat board surface of the power board, the chamber member may include a first terminal and a second terminal configured to protrude toward the power board unit so as to electrically come into contact with the first ring electrode and the second ring electrode, and the first ring electrode may supply the power to the Peltier element, and the second ring electrode may supply the power to the temperature sensor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating the exterior configuration of a dental material heating infuser according to an exemplary embodiment of the present invention;

FIG. 2 is a cross-sectional view illustrating the interior configuration of the dental material heating infuser according to the exemplary embodiment of the present invention;

FIG. 3 is a perspective view illustrating the interior configuration of the dental material heating infuser according to the exemplary embodiment of the present invention;

FIG. 4 is a perspective view illustrating the configuration of a heating unit in the dental material heating infuser according to the exemplary embodiment of the present invention;

FIG. 5 is a front cross-sectional view illustrating another embodiment of the heating unit in the dental material heating infuser according to the exemplary embodiment of the present invention;

FIG. 6 is a perspective view illustrating the exterior configuration of a dental material heating infuser according to an alternative embodiment of the exemplary embodiment of the present invention;

FIG. 7 is a perspective view illustrating the interior configuration of the dental material heating infuser according to the alternative embodiment of the exemplary embodiment of the present invention;

FIG. 8 is a perspective view illustrating the exterior configuration of a dental material heating infuser according to a further embodiment of the present invention;

FIG. 9 is a perspective view illustrating the interior configuration of the dental material heating infuser according to the further embodiment of the present invention;

FIG. 10 is an exploded perspective view illustrating the configuration of a heating unit and a protective casing in the dental material heating infuser according to the further embodiment of the present invention;

FIG. 11 is a side cross-sectional view illustrating the configuration of the dental material heating infuser according to the further embodiment of the present invention;

FIG. 12 is a perspective view illustrating the coupling relationship of the heating unit and a chamber member in the dental material heating infuser according to the further embodiment of the present invention;

FIG. 13 is a cross-sectional view illustrating the coupling relationship of the heating unit and a chamber member in the dental material heating infuser according to the further embodiment of the present invention;

FIG. 14 is a view illustrating the enlarged configuration of a front portion of the heating unit in the dental material heating infuser according to the further embodiment of the present invention; and

FIG. 15 is a view illustrating the enlarged configuration of a front portion of the dental material heating infuser according to an alternative embodiment of the further embodiment of the present invention.

### DESCRIPTION OF REFERENCE NUMERALS

100: dental material heating infuser

110: housing

111: first side surface housing

111a: upper housing

111b: handle housing

113: second side surface housing

115: display window

120: protective casing

121: outer casing

123: radiative casing

130: cartridge

131: cartridge main body

133: needle

135: hub

140: cartridge drive unit

141: piston

143: screw

145: drive motor

149: battery

160: heating unit

161: heating pipe

162: connection rib

163: Peltier element

163a: heating surface

163b: cooling surface

180: controller

181: input button

183: board

200: dental charger

210: charger main body

211: upper housing

211a: outer introduction hole

213: handle housing

215: battery

217: PCB

220: protective casing

221: outer casing

223: cooling casing

230: needle member

240: rotating unit

241: power board unit

241a: power board

241b, 241c: first ring electrode

241d, 241e: second ring electrode

250: chamber member

251: inner introduction hole

255a, 255b: first terminal

255c: first power supply line

257a, 257b: second terminal

257c: temperature sensor supply line

260: piston unit

261: manual rotating shaft

263: piston member

265: elastic member

270: operating unit

271: operating handle

273: tact switch

275: link unit

280: heating unit

281: heating pipe

281a: element coupling plate

283: Peltier element

283a: heating surface

283b: cooling surface

285: body heater

287: temperature sensor

### DETAILED DESCRIPTION OF THE INVENTION

To assist sufficient understanding of the present invention, exemplary embodiments of the present invention will be described below with reference to the accompanying drawings. The embodiments of the present invention may be altered in various ways, and the scope of the present invention should not be construed to be limited to the embodiments of the present invention, which are described below in detail. The embodiments are provided to more completely explain the present invention to one of ordinary skill in the art. Thus, the shape and the like of elements may be exaggerated in order to clarify the description. It should be noted that the same reference numbers will be used throughout the drawings to refer to the same or like parts. A detailed description of known functions or configurations incorporated herein will be omitted when it may make the subject matter of the disclosure rather unclear.

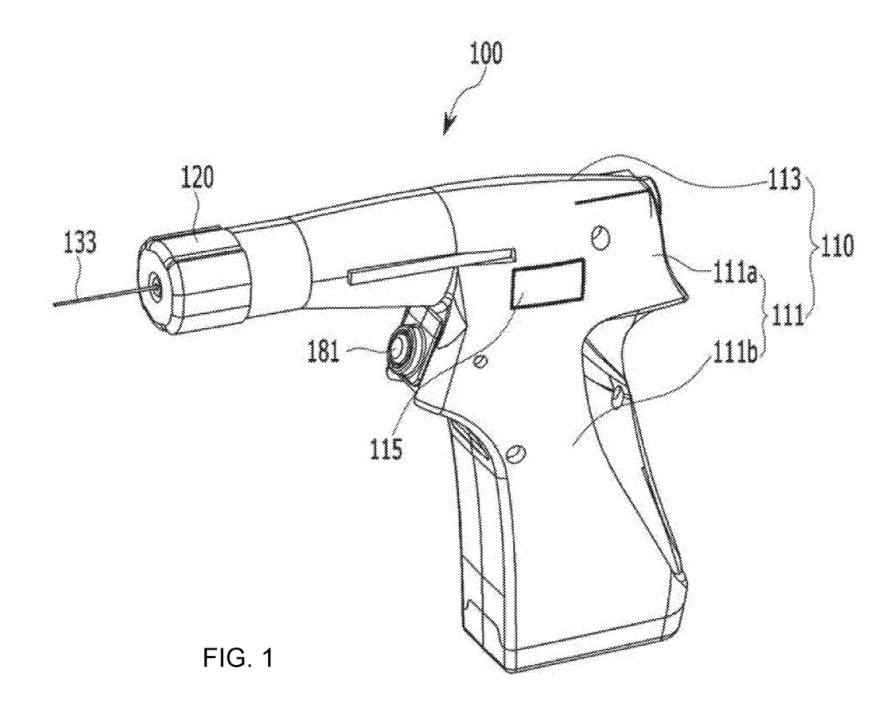

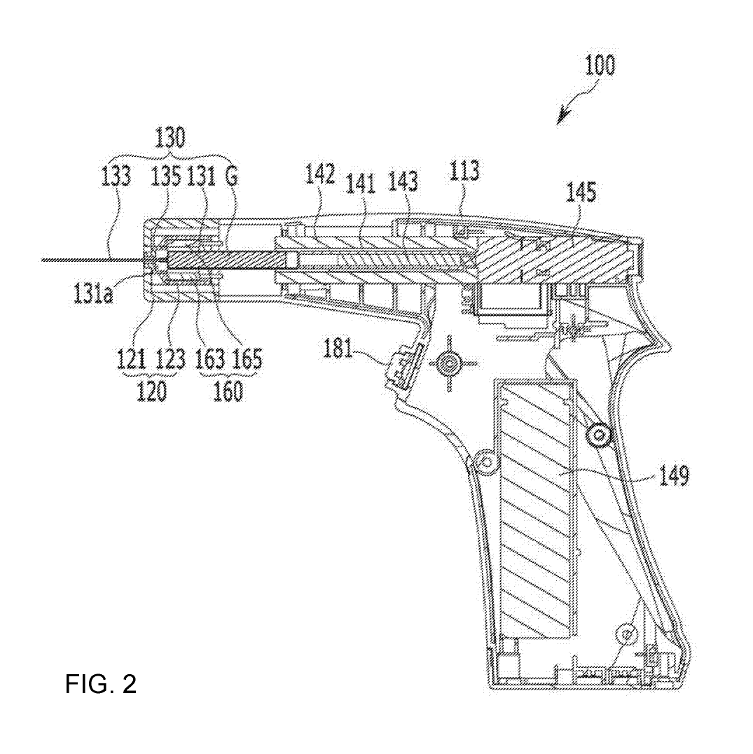

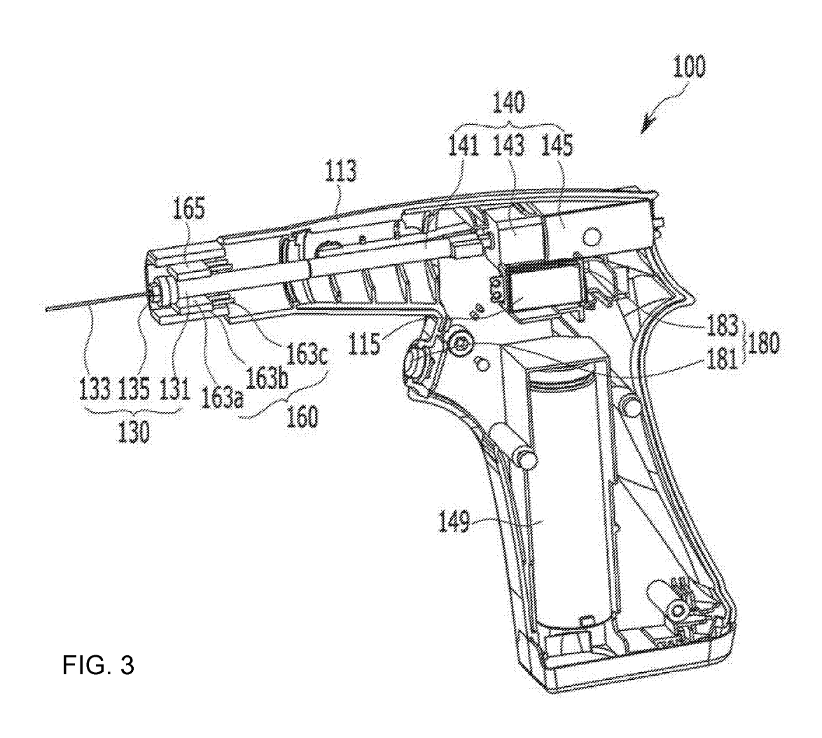

FIG. 1 is a perspective view illustrating the exterior configuration of a dental material heating infuser 100 according to an exemplary embodiment of the present invention, FIG. 2 is a cross-sectional view illustrating the interior configuration of the dental material heating infuser 100 according to the exemplary embodiment of the present invention, and FIG. 3 is a perspective view illustrating the interior configuration of the dental material heating infuser 100.

As illustrated, the dental material heating infuser 100 according to the exemplary embodiment of the present invention includes a housing 110, which forms the overall shape of a gun, a cartridge 130, which is detachably coupled to the front end of the housing 110 and accommodates a dental material G therein so as to discharge the dental material G outward by driving of a cartridge drive unit 140, a heating unit 160, which is fixedly coupled to the front end of the housing 110 and heats the dental material G using the Peltier effect, the cartridge drive unit 140, which applies pressure to the rear end portion of the cartridge 130 so as to discharge the dental material G outward, and a controller 180, which controls the cartridge drive unit 140 and the heating unit 160.

The housing 110 consists of a first side surface housing 111 and a second side surface housing 113, which are arranged on left and right sides of the housing 110 and are coupled to each other so as to define an accommodating space therein. The first side surface housing 111 and the second side surface housing 113, which are coupled to each other, form the overall shape of a gun. The first side surface housing 111 includes an upper housing 111a in which the cartridge 130, the cartridge drive unit 140, and the heating unit 160 are accommodated, and a handle housing 111b, which extends downward from the rear end of the upper housing 111a to allow a user to grip the handle housing 111b with the hand.

The first side surface housing 111 and the second side surface housing 113 are symmetrical to each other, and define therein the accommodating space in which the cartridge drive unit 140 and the heating unit 160 are accommodated. When the first side surface housing 111 and the second side surface housing 113 are coupled to each other, the front end of the upper housing 111a is open so that the cartridge 130 is detachably coupled thereto.

A display window 115 is formed in the flat surface of the handle housing 111b. The display window 115 displays, for example, a medical procedure time or a medical procedure temperature. For example, a battery 149 and a board 183 are accommodated in the handle housing 111b.

The protective casing 120 is detachably coupled to the front end of the housing 110. The protective casing 120 accommodates the cartridge 130 and the heating unit 160 therein. The protective casing 120 prevents the heat generated in the heating unit 160 from being transferred to the mouth and lips of a patient. The protective casing 120 is separated from the front end of the housing 110 when the cartridge 130 is replaced, and is re-coupled to the housing 110 after the cartridge 130 is inserted.

The protective casing 120 includes an outer casing 121 exposed to the outside, and a radiative casing 123 located between the outer casing 121 and Peltier elements 163 and 165. The outer casing 121 may be formed of silicon, and the radiative casing 123 may be formed of a metal material having good heat transfer efficiency.

Here, in each of the Peltier elements 163 and 165 according to the present invention, a heating surface 163a emits heat up to a maximum of 200° C., and the opposite upper surface 163b emits heat up to a maximum of 130° C. Thus, the radiative casing 123 and the outer casing 121 are designed to endure heat of a maximum of 130° C. and to discharge heat outward.

The radiative casing 123, as illustrated in FIG. 2, is located so as to come into contact with the upper surface 163b of each Peltier element 163 or 165. Thus, the heat generated in the upper surface 163b of each Peltier element 163 or 165 is radiated outward. The radiative casing 123 may be formed of a metal material having good heat transfer efficiency, such as aluminum, because it needs to rapidly radiate heat. In some cases, the radiative casing 123 may include a plurality of radiating fins (not illustrated) formed on the inner surface thereof in order to increase heat radiation efficiency.

The outer casing 121 surrounds the exterior of the radiative casing 123. The outer casing 121 may come into contact with the mouth and lips of the patient when the dental material G is charged. Because the patient may feel heat when the radiative casing 123 comes into contact with the mouth and lips, the outer casing 121 covers the radiative casing 123 to prevent the patient from feeling heat.

At this time, in order to increase heat radiation efficiency of the radiative casing 123, a heat sink (not illustrated) may be additionally provided between the radiative casing 123 and the outer casing 121. In addition, vent holes (not illustrated) may be formed in the radiative casing 123 and the outer casing 121 to increase heat radiation efficiency.

The outer casing 121 may be formed of an elastic silicon material. Because the outer casing 121 comes into contact with the mouth and lips of the patient, the outer casing 121 is designed for single use only and needs to be replaced for each medical procedure.

The cartridge 130 is detachably coupled to the front end of the housing 110 while accommodating the dental material G therein. The cartridge 130 includes a cartridge main body 131 in which the dental material G is accommodated, a needle 133, which is coupled to the front end of the cartridge main body 131 so as to discharge the dental material G outward, and a hub 135, which is coupled to the coupling region of the needle 133 and the radiative casing 123 so as to fix the cartridge main body 131 to the radiative casing 123.

The cartridge main body 131 has a circular tubular shape and the rear end of the cartridge main body 131 is open. The dental material G, which is in a solid state, such as solid gutta-percha or a resin, is accommodated inside the cartridge main body 131. Because the rear end of the cartridge main body 131 is open, the dental material G is exposed to the inside of a heating pipe 161 when the cartridge main body 131 is inserted into the heating pipe 161. At this time, the dental material G comes into contact with a piston 141, thereby applying pressure to the dental material G so that the dental material G is discharged outward.

The cartridge main body 131 is formed of a metal material in order to rapidly transfer the heat applied from the Peltier elements 163 and 165 to the dental material G.

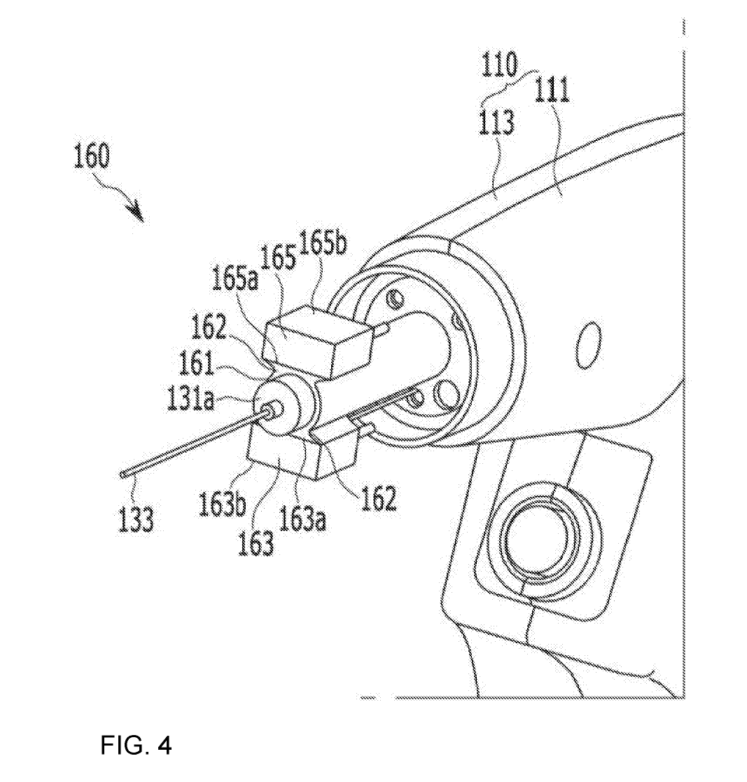

As illustrated in FIG. 4, the needle 131 is coupled to the front end 131a of the cartridge main body 131. The cartridge main body 131 receives heat from the Peltier elements 163 and 165 in the state in which it is accommodated inside the heating pipe 161. The solid dental material G is melted and discharged in a gel state by the heat applied from the Peltier elements 163 and 165.

The hub 135 is inserted into the gap space between the front end 131a of the cartridge main body 131 and the radiative casing 123 so as to fix the position of the cartridge main body 131. The user may separate the hub 135 so as to separate the cartridge main body 131 outward or insert the cartridge main body 131 into the heating pipe 161.

The cartridge drive unit 140 applies pressure to the cartridge 130 under the control of the controller 180 depending on whether an input button 181 is pushed or not, thereby causing the dental material G to be discharged through the needle 133. The cartridge drive unit 140, as illustrated in FIG. 3, includes the piston 141 disposed on the rear end of the cartridge 130, a screw 143 coupled to the rear end of the piston 141 so as to linearly move the piston 141 via driving of a drive motor 145, the drive motor 145 for driving the screw 143, and the battery 149 for supplying power to the drive motor 145.

The piston 141 is brought into contact with and applies pressure to the rear end of the dental material G. When the cartridge main body 131 is inserted into the heating pipe 161, the rear end of the dental material G is inserted into the piston 141, causing the piston 141 to be fixed at a position.

The screw 143 is fixedly coupled inside the rear end of the piston 141. When the screw 143 is moved forward or backward via driving of the drive motor 145, the piston 141 is moved forward or backward along with the screw 143. When the piston 141 is moved forward, the dental material G receives pressure so as to be discharged, thereby being discharged in a liquid state by the heating of the heating unit 160. Here, the piston 141 is moved while being accommodated in a housing 142.

The drive motor 145 is driven upon receiving power from the battery 149 under the control of the controller 180. The screw 143 is coupled to a drive shaft (not illustrated) of the drive motor 145 so as to be rotated forward or in reverse, thereby moving the piston 141 forward or backward.

The heating unit 160 heats and softens the dental material G, which is supplied from the cartridge 130 to the needle 133. The heating unit 160 heats the dental material G using the Peltier effect. FIG. 4 is an enlarged perspective view illustrating the configuration of the heating unit 160.

The heating unit 160 includes the heating pipe 161 for accommodating the cartridge 130 therein, the two Peltier elements 163 and 165, which are respectively located above and below the heating pipe 161 so as to heat the heating pipe 161, and a connection rib 162 for interconnecting the heating pipe 161 and the Peltier elements 163 and 165. The heating pipe 161, as illustrated in FIG. 2, accommodates the cartridge 130 inside the front end thereof, and accommodates the piston member 263 inside the rear end thereof. The heating pipe 161 is heated by the heat transferred from the Peltier elements 163 and 165, and the heat is transferred to the cartridge 130 to soften the dental material G.

The heating pipe 161 takes the form of a circular pipe, and the connection rib 162 connected to the Peltier elements 163 and 165 is provided on the outer circumferential surface of the heating pipe 161. Each of the Peltier elements 163 and 165 takes the form of a rectangular box having the heating surface 163a and the cooling surface 163b. When the Peltier elements 163 and 165 are arranged in a tangential direction on the outer circumferential surface of the heating pipe 161, which takes the form of a circular pipe, the contact area is reduced, which reduces heating efficiency.

Therefore, the connection rib 162 is located on the top and bottom of the heating pipe 161 so that the contact area between the connection ribs 162 and each of the Peltier elements 163 and 165 has a flat plate shape. The area of the connection rib 162, as illustrated in FIG. 4, corresponds to the width of each Peltier element 163 or 165. The heating surface 163a of each Peltier element 163 or 165 is seated on and brought into contact with the flat end of the connection rib 162.

An adhesive member (not illustrated) is disposed on the coupling surface of the connection rib 162 and each Peltier element 163 or 165 so as to fix the relative positions of the same. Alternatively, a physical fixing member (not illustrated) may be provided on opposite side surfaces of the Peltier elements 163 and 165 so as to fix the Peltier elements 163 and 165 to the connection rib 162 or the heating pipe 161. In this way, the positions of the Peltier elements 163 and 165 may be fixed.

When power is applied to each of the Peltier elements 163 and 165 and heat is generated from the heating surface 163a, the heat is transferred to the heating pipe 161 through the connection rib 162. In the Peltier elements 163 and 165, due to the Peltier effect, the heating surface 163a generates heat, whereas the cooling surface 163b opposite the heating surface 163a is cooled. When a DC voltage is applied to both ends 163c of the Peltier elements 163 and 165, the cooling surface 163b absorbs heat, thus exerting cooling effects, and the opposite heating surface 163a emits heat, depending on the direction of current.

In the Peltier elements 163 and 165 according to the present invention, the heating surface 163a emits heat within a temperature range from 160° C. to 220° C., and the cooling surface 163b has a temperature difference of 70° C. from the heating surface 163a and thus emits heat within a temperature range from 90° C. to 130° C. Although the cooling surface 163b has a lower temperature than the heating surface 163a, the cooling surface 163b rapidly radiates heat outward when brought into contact with the radiative casing 123 because the temperature range thereof, from 90° C. to 130° C., is high.

The controller 180 controls the cartridge drive unit 140 and the heating unit 160 to be operated in response to a user input signal. The controller 180 transmits the power of the battery 149 to the drive motor 145 in response to an input signal of the input button 181, which protrudes outward from the handle housing 111b. The controller 180 takes the form of a board 183 located below the screw 143.

Here, the Peltier elements 163 and 165 and the board 183 are connected to each other via a temperature sensor (not illustrated) so that the controller 180 senses the temperature of the Peltier elements 163 and 165 and limits the maximum temperature of the Peltier elements 163 and 165. The current temperature of the Peltier elements 163 and 165 is displayed on the display window 115.

The operating procedure of the dental material heating infuser 100 according to the present invention having the above-described configuration will be described below with reference to FIGS. 1 to 4.

The user separates the outer casing 121 from the front end of the upper housing 111a, and thereafter inserts a new cartridge 130, which is charged with the dental material G, into the heating pipe 161. At this time, a sensor (not illustrated) for sensing the maximally forwardly moved position and the maximally backwardly moved position of the piston 141 is provided inside the heating pipe 161. When the piston 141 reaches the maximally forwardly moved position thereof, the drive motor 145 is driven based on the sensing of the sensor so that the piston 141 is automatically moved backward.

After the cartridge main body 131 is coupled into the heating pipe 161, the user inserts the hub 135 between the radiative casing 123 and the front end 131a of the cartridge main body 131 so as to fix the position of the cartridge main body 131. Then, the user couples the outer casing 121 to the outside of the radiative casing 123.

When the user pushes the input button 181, the power of the battery 149 is transmitted to the Peltier elements 163 and 165. When power is supplied, as illustrated in FIG. 4, current flows to the Peltier elements 163 and 165, and the heating surface 163a, which comes into contact with the heating pipe 161, emits heat.

The connection rib 162, which comes into contact with the heating surface 163a, and the heating pipe 161 are heated, and the dental material G in the cartridge main body 131, which is accommodated inside the heating pipe 161, is heated and softened. At this time, the outer cooling surface 163b of each Peltier element 163 or 165, which comes into contact with the radiative casing 123, is cooled, and the radiative casing 123 outwardly radiates heat. The outer casing 121 surrounds the radiative casing 123 to prevent the heat from being directly transferred to the mouth and lips of the patient.

When the user pushes the input button 181, the screw 143 and the piston 141 are moved forward via driving of the drive motor 145 so as to apply pressure to the rear end of the dental material G, thereby causing the dental material G to be moved toward the needle 133.

At this time, because the dental material G is heated by the Peltier elements 163 and 165, the dental material G is supplied in a softened state.

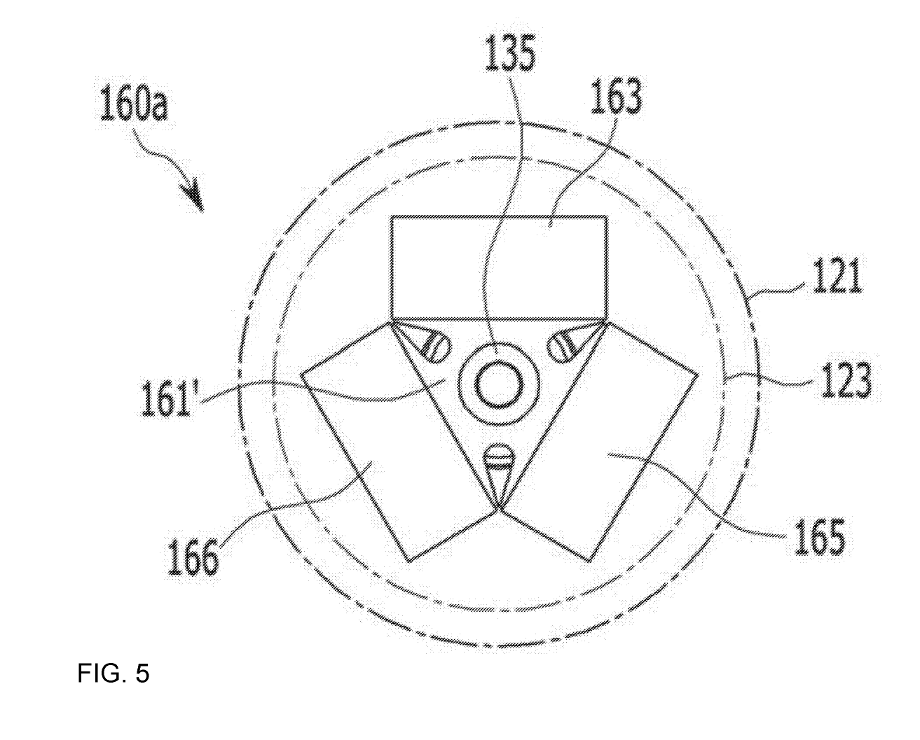

Meanwhile, FIG. 5 is a front cross-sectional view illustrating an alternative embodiment of a heating unit 160a in the dental material heating infuser according to the present invention.

In the dental material heating infuser 100 according to the above-described exemplary embodiment of the present invention, as illustrated in FIG. 4, the connection rib 162 is coupled to the top and bottom of the heating pipe 161. However, in the heating unit 160a according to the present embodiment, Peltier elements 163, 165 and 166 are arranged in a triangular form around a heating pipe 161′. That is, two or more Peltier elements, e.g. the Peltier elements 163, 165 and 166, may be arranged around the heating pipe 161′ depending on the supply amount, the supply rate, and the kind of the dental material G. To this end, the outer circumferential surface of the heating pipe 161′ may have a polygonal shape, such as, for example, a triangular shape, a square shape, or a pentagonal shape, and the Peltier elements 163, 165 and 166 may be arranged on the polygonal outer circumferential surface.

When the number of Peltier elements 163, 165 and 166 is increased, the amount of heat that is generated is increased, and thus the dental material G may be heated at a higher rate.

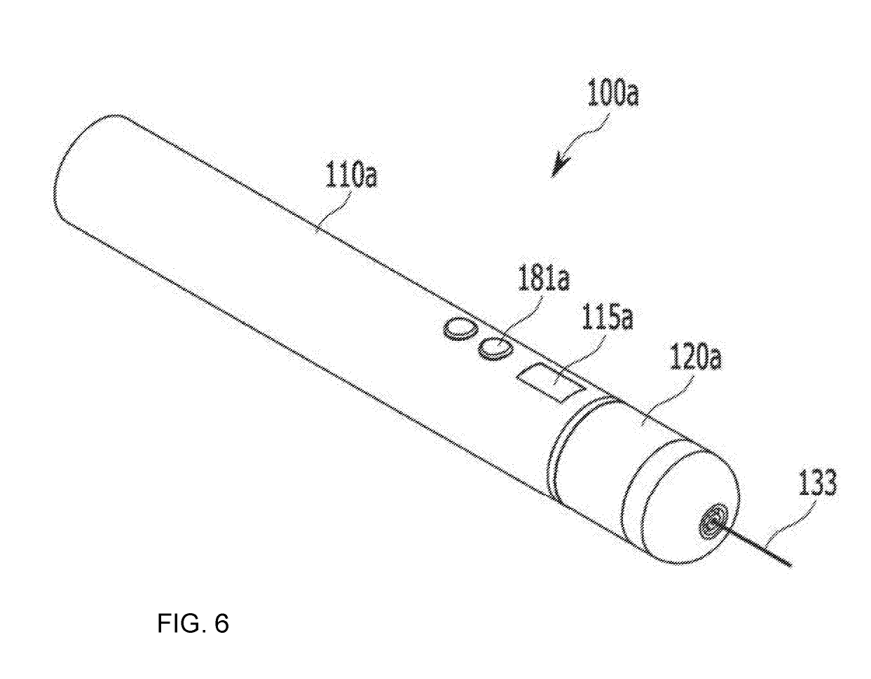

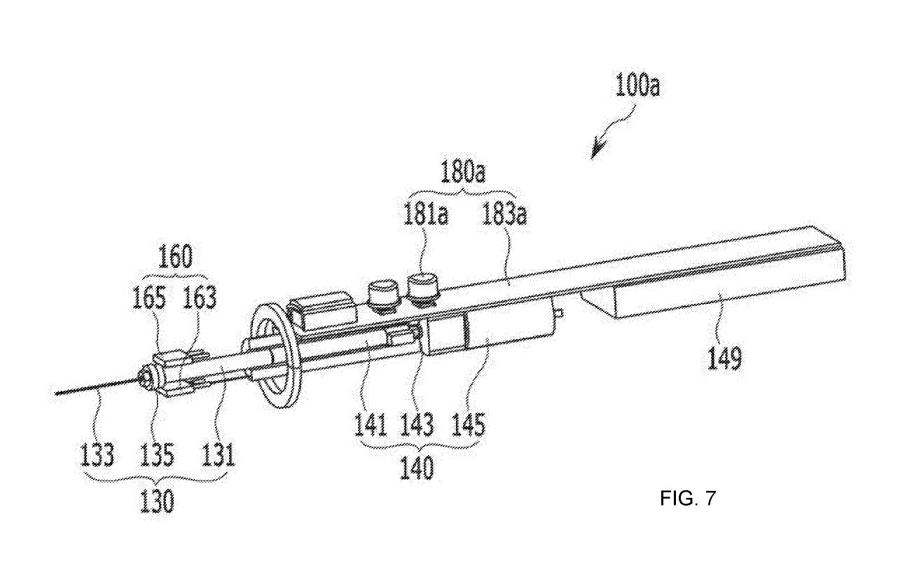

Meanwhile, FIGS. 6 and 7 are respectively perspective views illustrating the exterior configuration and the interior configuration of a dental material heating infuser 100a according to an alternative embodiment of the exemplary embodiment of the present invention.

In the dental material heating infuser 100 according to the above-described exemplary embodiment of the present invention, the outer housing 110 takes the form of a gun. Thus, during a medical procedure, the user grips the handle housing 111b with the hand so that the front end of the upper housing 111a faces the mouth and lips of the patient.

On the other hand, in the dental material heating infuser 100a according to the alternative embodiment, an outer housing 110a takes the form of a pen. That is, because the outer housing 110a is formed in a linear cylindrical pipe shape, the user will grip the rear end of the outer housing 110a during a medical procedure.

An input button 181a and a display window 115a are provided on the outer circumferential surface of the outer housing 110a. A protective casing 120a is coupled to the front end of the outer housing 110a, and the cartridge 130 is provided inside the outer housing 110a.

As illustrated in FIG. 7, a board 183a penetrates the inside of the outer housing 110a, and the cartridge drive unit 140 is provided below the board 183a.

The dental material heating infuser 100 according to the exemplary embodiment of the present invention and the dental material heating infuser 100a according to the alternative embodiment have different exterior shapes, i.e. a gun shape and a pen shape, but have the same driving mechanism of heating the cartridge 130 via the Peltier elements 163 and 165 and discharging the cartridge 130 outward.

As described above, the dental material heating infuser 100 according to the exemplary embodiment of the present invention heats the cartridge using the Peltier effect, thus causing low heat loss and increased thermal efficiency.

In addition, because only the cartridge is heated and heat is rapidly radiated outward, even if the protective casing comes into contact with the mouth and lips of the patient, no heat is transferred, and safe use is possible.

In addition, because a constant amount of heat is generated regardless of external conditions, a dental material may be heated to a constant temperature.

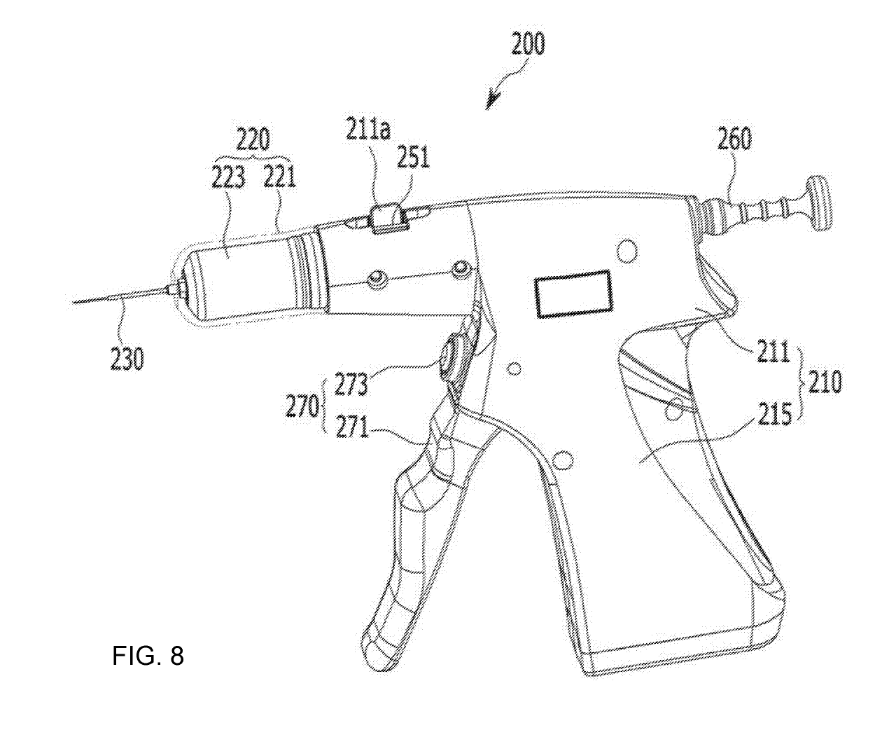

Meanwhile, FIGS. 8 to 15 are views illustrating the configuration of a dental material heating infuser 200 according to a further embodiment of the present invention.

The dental material heating infuser 100 according to the above-described exemplary embodiment and the dental material heating infuser 200 according to the further embodiment are similar to each other in terms that they have a gun shape and heat the dental material G using the Peltier elements. However, there is a difference as to the method of charging the dental material G.

That is, the dental material heating infuser 100 according to the exemplary embodiment exchanges the dental material G by inserting the cartridge 130, which is charged with the dental material G, into the heating pipe 161. Unlike this, the dental material heating infuser 200 according to the further embodiment is provided with an outer introduction hole 211a in the surface of the housing 211 for introduction of the dental material G, and a chamber member 250 in which the dental material G is accommodated is provided inside the housing 111.

Hereinafter, the configuration of the dental material heating infuser 200 according to the further embodiment will be described in detail.

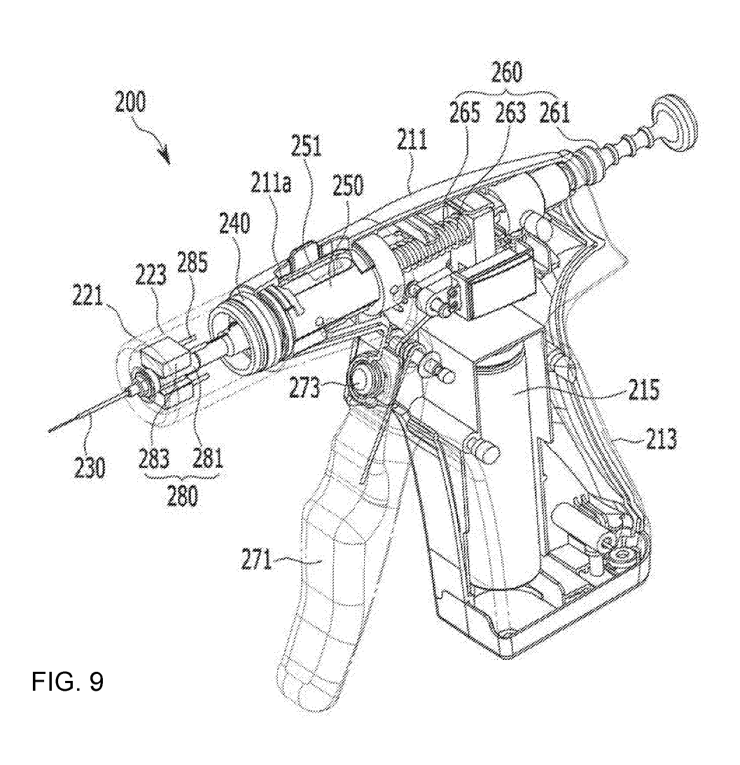

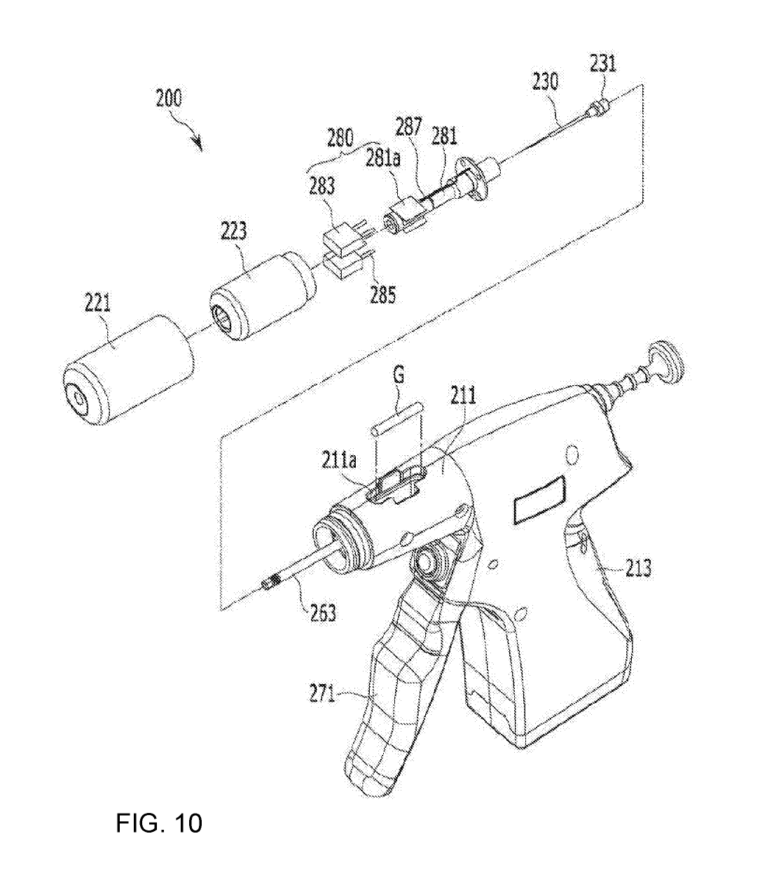

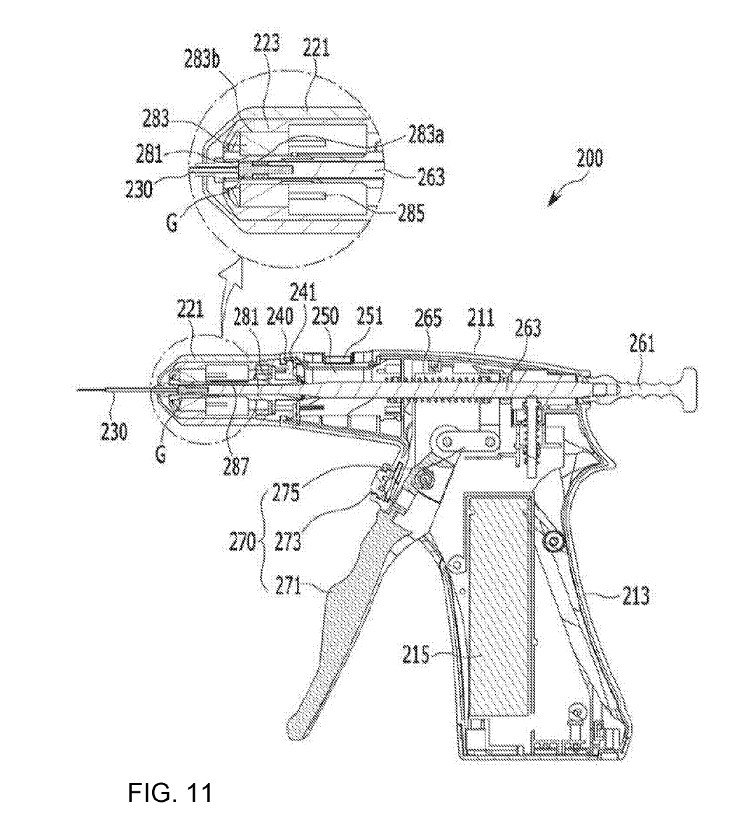

FIG. 8 a perspective view illustrating the exterior configuration of the dental material heating infuser 200 according to the further embodiment of the present invention, FIG. 9 is a perspective view illustrating the interior configuration of the dental material heating infuser 200, FIG. 10 is an exploded perspective view illustrating the configuration of the dental material heating infuser 200, and FIG. 11 is a side cross-sectional view illustrating the configuration of the dental material heating infuser 200.

As illustrated, the dental material heating infuser 200 according to the further embodiment of the present invention includes a charger main body 210, which forms the overall shape of a gun, a chamber member 250, which is detachably coupled to the front end of the charger main body 210 and accommodates therein the dental material G having a pellet shape, a heating unit 280, which is coupled to the front end of the charger main body 210 so as to heat the dental material G using the Peltier effect, a needle member 230, which is coupled to the front end of the heating unit 280 so as to discharge the dental material G outward, a rotating unit 240, which is coupled to the heating unit 280 and is rotated inside the charger main body 210, a piston unit 260, which is movable forward or backward inside the chamber member 250 and applies pressure to the dental material G so as to discharge the dental material G to the needle member 230, and an operating unit 270, which operates the piston unit 260.

The charger main body 210 includes an upper housing 211 in which the piston unit 260 is accommodated, and a handle housing 213, which extends downward from one side of the upper housing 211 and serves as a handle to be gripped by the user's hand.

The handle housing 213 accommodates a battery 215, a circuit board 217, and the operating unit 270 therein. The upper housing 211 is provided with an outer introduction hole 211a, through which the dental material G is introduced into the chamber member 250.

A protective casing 220 is detachably coupled to the front end of the upper housing 211. The protective casing 220 serves to prevent the heat of the heating unit 280 accommodated therein from being directly discharged outward.

The protective casing 220 includes an outer casing 221 exposed to the outside, and a radiative casing 223 located between the outer casing 221 and a Peltier element 283. The outer casing 221 may be formed of silicon, and the radiative casing 223 may be formed of a metal material having good heat transfer efficiency.

Here, the Peltier element 283 according to the further embodiment of the present invention has a heating surface 283a, which emits heat up to a maximum of 200° C., and the opposite cooling surface 283b, which emits heat up to a maximum of 230° C. Thus, the radiative casing 223 and the outer casing 221 are designed to endure heat up to a maximum of 230° C. and to discharge the heat outward.

The radiative casing 223, as illustrated in FIG. 11, is disposed so as to come into contact with the upper surface 283b of the Peltier element 283. Thus, the radiative casing 223 absorbs heat generated from the upper surface of the Peltier element 283 and discharges the heat outward. The radiative casing 223 may be formed of aluminum having good heat transfer efficiency because it needs to rapidly radiate the heat outward. In some cases, a heat sink (not illustrated), such as radiating fins (not illustrated), may be provided on the inner surface of the radiative casing 223, in order to further increase the heat radiation efficiency of the radiative casing 223.

The outer casing 221 surrounds the exterior of the radiative casing 223. The outer casing 221 is brought into contact with the mouth and lips of the patient when the dental material G is charged. Because the patient may feel heat when the radiative casing 223 comes into contact with the mouth and lips of the patient, the outer casing 221 covers the radiative casing 223 to prevent the patient from feeling heat. The outer casing 221 may be formed of an elastic silicon material.

The needle member 230 is coupled to the front end of the heating unit 280. The needle member 230 supplies the dental material G heated by the heating unit 280 to the mouth and lips of the patient.

The rotating unit 240 is coupled to the rear end of the heating unit 280 and is rotated, along with the heating unit 280, independently of the upper housing 211. The rotating unit 240 is rotatably installed inside the protective casing 220, and has a hollow structure so that a piston member 263 is accommodated therein. The rotating unit 240 and the protective casing 220 are idle-rotatably coupled to the chamber member 250 when the user applies pressure thereto. Thus, the user rotates the rotating unit 240 so that the needle member 230 is located at a desired position based on the relative position of the patient and the position of a tooth to be treated during a medical procedure.

The rotating unit 240 is fixedly coupled to the rear end of a heating pipe 281 of the heating unit 280 via, for example, a coupling hub (not illustrated). The rotating unit 240 is rotated while being coupled to the end of the upper housing 211 via the coupling of a rotating groove and a guide rib.

Meanwhile, a power board unit 241 for supplying power to the heating unit 280 is provided on the rear end portion of the rotating unit 240, i.e. on the side facing the chamber member 250. The power board unit 241 receives power from the chamber member 250 and supplies the power to the Peltier element 283 of the heating unit 280 and a temperature sensor 287. The power board unit 241 includes a disc-shaped power board 241a, and first ring electrode 241b and 241c and second ring electrodes 241d and 241e, which have different diameters and are concentrically arranged on the flat surface of the power board 241a. Each of the first ring electrodes 241b and 241c and the second ring electrodes 241d and 241e takes the form of a groove having a constant depth. Here, the cross-sectional shape of the groove-shaped first ring electrodes 241b and 241c and second ring electrodes 241d and 241e corresponds to the shape of the ends of first terminals 255a and 255b and second terminals 257a and 257b, which will be described later.

The chamber member 250 is accommodated inside the protective casing 220. The chamber member 250 accommodates the dental material G therein. The upper portion of the chamber member 250 is provided with an inner introduction hole 251, through which the dental material G in a solid form is introduced. The rear end portion of the dental material G, accommodated inside the chamber member 250 through the inner introduction hole 251, is located such that it comes into contact with the piston member 263. When the piston member 263 is moved forward via the operation of a operating handle 271, pressure is applied to the dental material G.

As such, the dental material G inside the chamber member 250 is discharged outward through the needle member 230 by way of the heating unit 280.

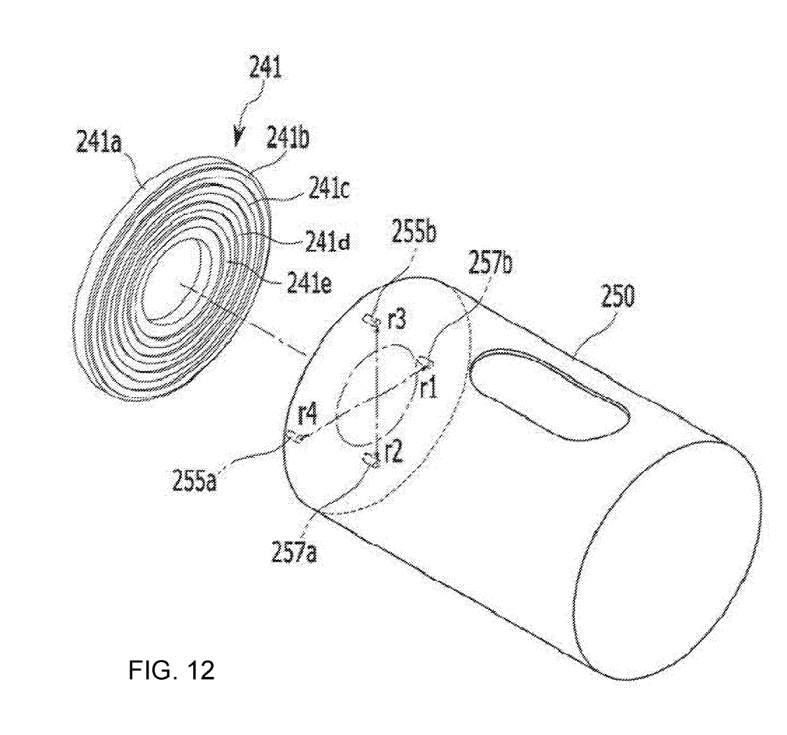

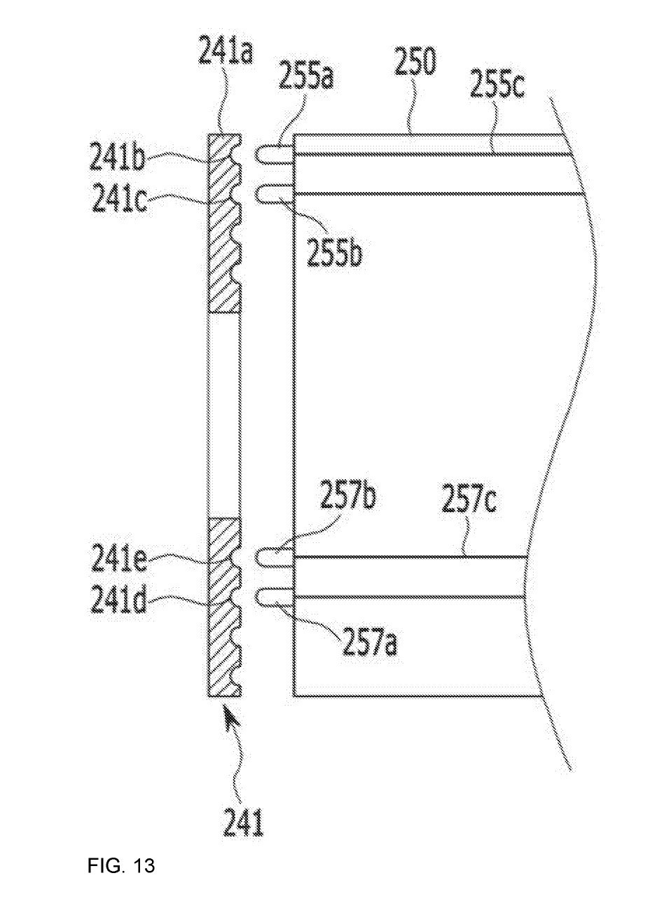

FIGS. 12 and 13 are respectively a perspective view and a side view illustrating the procedure of coupling the rotating unit 240 and the chamber member 250. As illustrated, the chamber member 250 is provided on the front surface thereof with the first terminals 255a and 255b and the second terminals 257a and 257b, which protrude toward the rotating unit 240. As described above, the first ring electrodes 241b and 241c and the second ring electrodes 241d and 241e are concentric grooves, and the first terminals 255a and 255b and the second terminals 257a and 257b are protrusions configured to be inserted into the first ring electrodes 241b and 241c and the second ring electrodes 241d and 241e respectively. The first ring electrodes 241b and 241c and the second ring electrodes 241d and 241e are located at different diametric distance from the center of the chamber member 250.

When the rotating unit 240 is rotated, the power board unit 241, which is fixedly coupled to the rotating unit 240, is rotated. At this time, even though the power board unit 241 is rotated, the first terminals 255a and 255b and the second terminals 257a and 257b remain in contact with the first ring electrodes 241b and 241c and the second ring electrodes 241d and 241e, and therefore the supply of power to the heating unit 280 may be smoothly performed.

Here, the first terminals 255a and 255b and the second terminals 257a and 257b are respectively connected to a first power supply line 255c and a temperature sensor supply line 257c. The first terminals 255a and 255b supply power to the Peltier element 283, and the second terminals 257a and 257b supply power to the temperature sensor 287. The first power supply line 255c and the temperature sensor supply line 257c are connected to the circuit board 217.

The piston unit 260 applies pressure to the chamber member 250 via the operation of the operating handle 271, thereby causing the dental material G to be discharged through the needle member 230. The piston unit 260 is coupled to a link unit 275, which is linked to the operating handle 271. The piston unit 260 includes the piston member 263 configured to apply pressure to the chamber member 250, and a return spring 265 for elastically returning the piston member 263 to an initial position thereof. A manual handle 261 is provided on the rear end portion of the piston member 263 so as to manually apply pressure to the piston member 263.

The operating unit 270 causes the piston unit 260 to apply pressure to the chamber member 250. The actuator 270 includes the operating handle 271, a tactile switch 273, and the link unit 275 for converting the pressure applied from the operating handle 271 into linear movement of the piston unit 260.

The operating handle 271 is pivotably coupled to the handle housing 213. When the user pushes the operating handle 271 toward the handle housing 213, the piston member 263 of the piston unit 260 is driven forward so as to apply pressure to the chamber member 250. The operating handle 271 and the piston member 263 are connected to each other via the link unit 275.

The tactile switch 273 is a switch for power on/off and temperature change. The dental material heating infuser 200 of the present invention displays a set temperature when power is applied, and begins to be heated. That is, the dental material heating infuser 200 is heated from the time at which it is powered on to reach a set reference temperature.

The heating unit 280 heats and softens the dental material G, which is supplied from the chamber member 250 to the needle member 230. The heating unit 230 heats the dental material G using the Peltier effect. FIG. 10 is an exploded perspective view illustrating the configuration of the heating unit 280, and FIG. 11 is an enlarged cross-sectional view illustrating the configuration of the heating unit 280.

The heating unit 280 includes the heating pipe 281 for accommodating the chamber member 250 therein, and a pair of Peltier elements 283, which are disposed respectively above and below the heating pipe 281 so as to heat the heating pipe 281. The heating pipe 281, as illustrated in FIG. 10, is coupled at the front end thereof to the needle member 230 and at the rear end thereof to the rotating unit 240. The heating pipe 281 is heated by the heat transferred from the Peltier elements 283. When the heat is transferred to the dental material G, which is moved to the needle member 230 upon receiving pressure from the piston member 263, the dental material G is softened.

Although the heating pipe 281 takes the form of a circular pipe, an element coupling plate 281a is provided in a flat form so as to be brought into contact with the heating surface 283a of the Peltier element 283. The Peltier element 283 takes the form of a rectangular box having the heating surface 283a and the cooling surface 283b. When the Peltier element 283 is disposed in a tangential direction on the outer circumferential surface of the heating pipe 281, which has a circular pipe shape, the contact area is small and the heating efficiency is reduced.

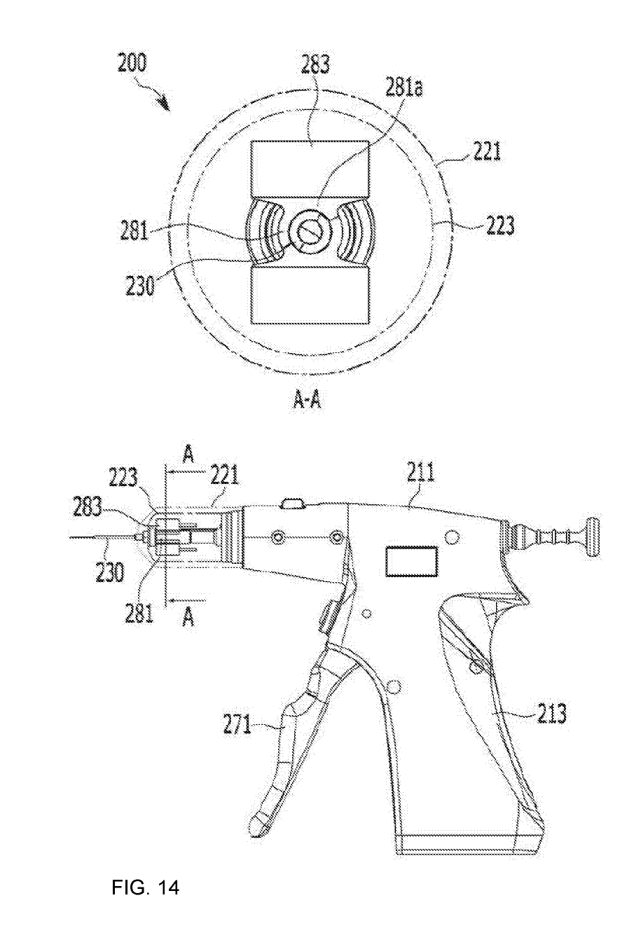

Therefore, the element coupling plate 281a having a flat plate shape is disposed on each of the top and the bottom of the heating pipe 281. The element coupling plate 281a, as illustrated in FIG. 14, has a width corresponding to the width of the Peltier element 283. The heating surface 283a of the Peltier element 283 is seated on and comes into contact with the element coupling plate 281a. When power is applied to the Peltier element 283 and heat is generated from the heating surface 283a, the heat is transferred to the heating pipe 281 through the element coupling plate 281a.

In the Peltier element 283, due to the Peltier effect, the heating surface 283a generates heat, whereas the cooling surface 283b opposite the heating surface 283a is cooled. When a DC voltage is applied to both ends 285 of the Peltier element 283, the cooling surface 283b absorbs heat, thus exerting cooling effects, and the opposite heating surface 283a emits heat, depending on the direction of current.

Meanwhile, the temperature sensor 287 is provided on the rear end of the heating pipe 281 to sense the temperature of the heating pipe 281, which is heated by the Peltier elements 283. A controller (not illustrated) controls the supply of power to the Peltier elements 283 based on the temperature sensed by the temperature sensor 287.

The operating procedure of the dental material heating infuser 200 according to the further embodiment of the present invention having the above-described configuration will be described below with reference to FIGS. 8 to 14.

The user inserts the dental material G into the inner introduction hole 251 of the chamber member 250 through the outer introduction hole 211a of the upper housing 211. To this end, the operator inserts the dental material G after retracting the piston member 263 backward.

When a power switch is turned on, the power of the battery 215 is transmitted to the Peltier elements 283 via contact between the first terminals 255a and 255b of the chamber member 250 and the first ring electrodes 241b and 241c on the power board 241a. When the power is supplied, as illustrated in FIG. 11, current flows to the Peltier elements 283, and the heating surface 283a, which comes into contact with the heating pipe 281, emits heat.

In addition, the piston member 263 is moved forward when the operating handle 271 is pushed, and the dental material G is moved to the heating pipe 280 through the rotating unit 240 by the pressure applied from the piston member 263.

The heating pipe 281 and the element coupling plate 281a, which comes into contact with the heating surface 283a, are heated, and the dental material G moved into the heating pipe 281 is heated and softened. At this time, the outer cooling surface 283b of the Peltier element 283, which comes into contact with the radiative casing 223, is cooled, and the radiative casing 223 radiates heat outward. The outer casing 221 surrounds the radiative casing 223 to prevent the heat from being directly transferred to the mouth and lips of the patient. At this time, because the temperature of the cooling surface 283b ranges from 90° C. to 230° C., and the temperature of the outer casing 221 is below 40° C., the patient does not feel heat.

When the user pushes the operating handle 271, the piston member 263 is continuously moved forward via the operation of the link unit 275, whereby the dental material G, which has been heated by the heating unit 230 and thus is in a soft state, is introduced into the needle member 230, and thereafter is supplied to a tooth of the patient.

Meanwhile, in this process, the user rotates the rotating unit 240 based on the position of the needle member 230 relative to the patient.

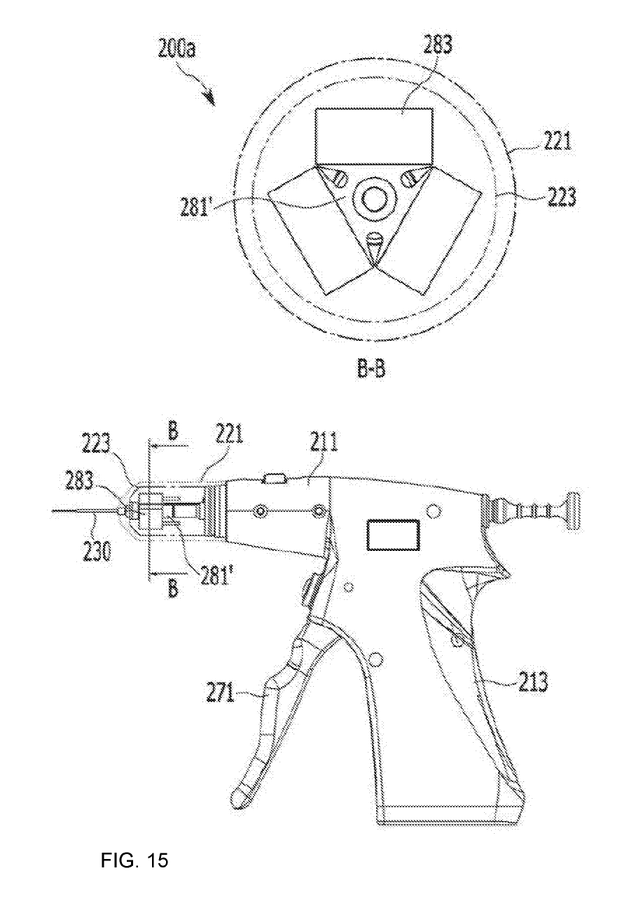

Meanwhile, FIG. 15 is a cross-sectional view illustrating the configuration of the cross section taken along line B-B of a dental material heating infuser 200a according to an alternative embodiment of the further embodiment of the present invention.

The dental material heating infuser 200 according to the above-described further embodiment of the present invention includes the element coupling plates 281a coupled respectively to the top and bottom of the heating pipe 281, as illustrated in FIG. 11. Unlike this, the dental material heating infuser 200a according to the alternative embodiment of the further embodiment includes Peltier elements 283, which are arranged in a triangular arrangement on a heating pipe 281′. That is, two or more Peltier elements 283 may be arranged on the heating pipe 281′ based on the supply amount, the supply rate, and the kind of the dental material G. To this end, element coupling plates may be arranged in a polygonal shape, such as, for example, a triangular shape, a square shape, or a pentagonal shape, on the outer circumference of the heating pipe 281′, and the Peltier elements 283 may be arranged on the outer circumferential surface of the polygon.

Because the amount of heat that is generated is increased as the number of the Peltier elements 283 is increased, the dental material G may be heated at an increased rate.

The embodiments of the dental material heating infuser of the present invention described above are merely provided by way of example, and it will be apparent to those skilled in the art that various modifications and other equivalent embodiments may be acquired from the embodiments. Hence, it can be well understood that the present invention is not limited to the forms mentioned in the above description. Accordingly, the technical range of the present invention should be determined by the technical sprit of the accompanying claims. In addition, it should be understood that the present invention includes all modifications, equivalents, and substitutions that fall within the scope and spirit of the present invention defined by the accompanying claims.

As is apparent from the above description, a dental material heating infuser according to the present invention may achieve increased thermal efficiency attributable to low heat loss because it heats a dental material using the Peltier effect.

In addition, because only a dental material cartridge is heated, a relatively low temperature of heat is dissipated outward, and a protective casing surrounds the outer periphery of the dental material cartridge, even if the protective casing comes into contact with the mouth and lips of a patient, no heat is transferred to the patient, which may ensure the safe use of the dental material heating infuser.

1. A dental material heating infuser comprising:
a housing having an open front end;
a cartridge detachably coupled to the open front end of the housing and configured to accommodate a dental material therein, a needle member for outwardly discharging the dental material being coupled to the cartridge;
a protective casing coupled to the front end of the housing so as to surround an exterior of the cartridge;
a heating unit provided between the protective casing and the cartridge for heating the cartridge; and
a cartridge drive unit for applying pressure to a rear end portion of the cartridge so that the dental material is discharged outward through the needle member,
wherein the heating unit includes:
a heating pipe, into which the cartridge is inserted; and
a Peltier element disposed on an outer circumferential surface of the heating pipe for supplying heat to the heating pipe by Peltier effect.

2. The dental material heating infuser according to claim 1, wherein the heating pipe is provided with a connection rib, which extends from the outer circumferential surface of the heating pipe to the Peltier element, the connection rib having a horizontal coupling area with respect to the Peltier element so as to come into surface contact with the Peltier element.

3. The dental material heating infuser according to claim 1, wherein the protective casing includes:
a radiative casing disposed so as to come into contact with the Peltier element and formed of a metal material for outwardly discharging the heat supplied from the Peltier element;
an outer casing configured to cover an exterior of the radiative casing in order to prevent the radiative casing from coming into contact with a mouth and lips of a patient; and
a heat sink provided between the radiative casing and the outer casing for outwardly discharging the heat transferred from the radiative casing.

4. The dental material heating infuser according to claim 3, wherein the Peltier element is provided in a plural number, and
wherein the heating pipe takes the form of a polygon, of which the number of sides corresponds to the number of Peltier elements.

5. The dental material heating infuser according to claim 1, wherein the housing includes:
an upper housing for accommodating the heating unit and the cartridge drive unit therein; and
a handle housing extending downward from a rear end of the upper housing so as to be gripped by a user, and
wherein the upper housing and the handle housing are coupled to each other to form a gun shape.

6. The dental material heating infuser according to claim 1, wherein the housing takes the form of a pen for accommodating the heating unit and the cartridge therein, the protective casing being coupled to the front end of the pen-shaped housing.

7. A dental material heating infuser comprising:
a charger main body having a handle housing for accommodating a battery therein and an upper housing provided at an upper side of the handle housing;
a chamber member coupled inside the upper housing and having a dental material insertion hole, through which a solid-state dental material from an outside is inserted into the chamber member, for accommodating the solid-state dental material therein;
a needle member coupled to a front end of the upper housing for discharging a liquid-state dental material to a dental area to be treated;
a heating unit for heating the solid-state dental material supplied from the chamber member so as to obtain the liquid-state dental material;
a rotator coupled to a rear end of the heating unit for providing drive power required to rotate the heating unit;
a piston unit movably provided inside the upper housing for pressing the solid-state dental material inside the chamber member to the heating unit;
an operating unit for driving the piston unit so that the dental material is supplied to the heating unit; and
a protective casing coupled to the front end of the upper housing for protecting the heating unit from an outside,
wherein the heating unit includes:
a heating pipe connected at a rear end thereof to the chamber member and connected at a front end thereof to the needle member so that the dental material is introduced from the chamber member into the heating pipe; and
a Peltier element disposed on an outer circumferential surface of the heating pipe for supplying heat to the heating pipe and cooling the protective casing by Peltier effect.

8. The dental material heating infuser according to claim 7, wherein the heating pipe has a circular cross-sectional shape, and
wherein the heating pipe is provided on an area of the outer circumferential surface thereof with an element coupling plate, which has a flat shape and is disposed so as to come into contact with the Peltier element.

9. The dental material heating infuser according to claim 7, wherein the protective casing includes:
a radiative casing disposed so as to come into contact with the Peltier element and formed of a metal material for outwardly discharging the heat supplied from the Peltier element; and
an outer casing configured to cover an exterior of the radiative casing in order to prevent the radiative casing from coming into contact with a mouth and lips of a patient.

10. The dental material heating infuser according to claim 9, wherein the Peltier element is provided in a plural number, and
wherein the heating pipe is provided with an element coupling plate, which is coupled to form a polygon, of which the number of sides corresponds to the number of Peltier elements.

11. The dental material heating infuser according to claim 10, further comprising:
a temperature sensor for sensing a temperature of the Peltier element; and
a power board unit for supplying power to the temperature sensor and the Peltier element,
wherein the power board unit includes:
a power board coupled between the chamber member and the rotator; and
a first ring electrode and a second ring electrode concentrically recessed to a constant depth in a flat board surface of the power board,
wherein the chamber member includes a first terminal and a second terminal configured to protrude toward the power board unit so as to electrically come into contact with the first ring electrode and the second ring electrode, and
wherein the first ring electrode supplies the power to the Peltier element, and the second ring electrode supplies the power to the temperature sensor.
